(19) United States
(12) Patent Application Publication
(10) Pub. No.: US 2003/0015070 A1
(43) Pub. Date: Jan. 23, 2003

(54) Wrench head angle adjustment mechanism

(76) Inventor: Ching Chen, Taiping City (TW)

Correspondence Address: Keith Kline, PRO-TECHTOR INTERNATIONAL SERVICES, 20775 Norada Court, Saratoga, CA, 95070-3018, US

(21) Appl. No.: 09/908,065

(22) Filed: Jul. 17, 2001

(51) Int. Cl. B25B 23/16

(52) U.S. Cl. 81/177.9

(57) ABSTRACT

An adjustable mechanism is mounted in a wrench. The mechanism comprises a cylindrical projection extended from a head of the wrench, the projection including a bore, a recessed portion on one end, and a plurality of dents on the other end around the bore; and a substantially U-shaped joint means at one end of a handle of the wrench, the joint means including a recess, a hole through two vertical portions of the joint means, an aperture adjacent the hole, an elastic member biased between the recessed portion and an inner side of one of the vertical portions, a pin through the hole and the bore to rotatably secure the projection and the joint means, a threaded aperture adjacent the hole, and a depressible spring detent secured within the aperture for urging against one of the dents in a normal position. Handle is pivotable to move detent from one dent to the other for adjusting an angle of wrench head with respect to handle.

### FIELD OF THE INVENTION

The present invention relates to wrenches and more particularly to a combination box and open end wrench with improved wrench head angle adjustment mechanism.

### BACKGROUND OF THE INVENTION

A conventional wrench is shown in FIGS. 1 and 2 comprising a head 1 having an enclosed box portion, a cylindrical projection 2 extended from head 1, a half circular toothed section 3 on the surface of cylindrical projection 2, a recess 5 on a substantially U-shaped end of handle 4, a pin 9 inserted through holes on end of handle 4 and cylindrical projection 2 to rotatably secure head 1 to handle 4, a receptacle 6 on the bottom of recess 5, a spring 7 anchored in receptacle 6, and a steel ball 8 urged against the valley of toothed section 3 by the elastically energized force applied from the spring 7 in a normally engaged state. In use, simply pivot head 1 about handle 4 to cause steel ball 8 to move from one valley to the other valley through peak(s) so as to obtain a desired angle of head 1 with respect to handle 4. Once adjusted, user may use the wrench to work.

But this is unsatisfactory for the purpose for which the invention is concerned for the following reasons: The engagement of steel ball 8 and valley of toothed section 3 may be not reliable after a prolonged period of time of use due to the elastic fatigue of spring 7. Further, dirt, dust or the like may accumulate on the teeth of toothed section 3 after a long use. And in turn it may malfunction the angle adjustment mechanism of the wrench. Furthermore, it is unsightly. Thus, it is desirable to provide a combination box and open end wrench with improved wrench head angle adjustment mechanism in order to overcome the above drawbacks of prior art.

### SUMMARY OF THE INVENTION

It is therefore an object of the present invention to provide an adjustable mechanism mounted in a wrench. The mechanism comprises a cylindrical projection extended from a head of the wrench, the projection including a bore, a recessed portion on one end, and a plurality of dents on the other end around the bore; and a substantially U-shaped joint means at one end of a handle of the wrench, the joint means including a recess, a hole through two vertical portions of the joint means, an aperture adjacent the hole, an elastic member biased between the recessed portion and an inner side of one of the vertical portions, a pin through the hole and the bore to rotatably secure the projection and the joint means, a threaded aperture adjacent the hole, and a depressible spring detent secured within the aperture for urging against one of the dents in a normal position; whereby pivot the handle about the projection to cause the detent to move from one of the dents to the other dent for adjusting an angle of the head with respect to the handle. By utilizing this, the engagement of detent and dent is reliable as time changes. Further, it is difficult for dirt, dust or the like to accumulate on the joint portion of projection and recess so as to preserve the appearance of wrench.

The above and other objects, features and advantages of the present invention will become apparent from the following detailed description taken with the accompanying drawings.

### BRIEF DESCRIPTION OF THE DRAWINGS

FIG. 1 is a plan view in part section of a portion of a conventional wrench with head angle adjustment mechanism;

FIG. 2 is a side view in part section of FIG. 1 showing the angle adjustment operation of the wrench head;

FIG. 3 is a plan view in part section of a portion of a preferred embodiment of combination box and open end wrench incorporating a wrench head angle adjustment mechanism according to the invention;

FIG. 4 is a perspective view of FIG. 3 wrench;

FIG. 5 is an exploded view of the components shown in FIG. 3;

FIG. 6 is a view similar to FIG. 3, the head being shown during mounting; and

FIG. 7 is a perspective view showing the angle adjustment operation of the wrench.

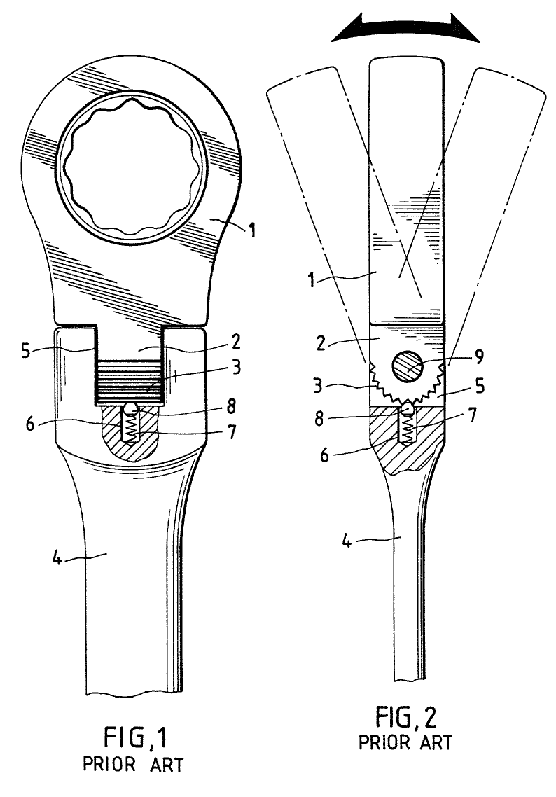

### DETAILED DESCRIPTION OF THE PREFERRED EMBODIMENTS

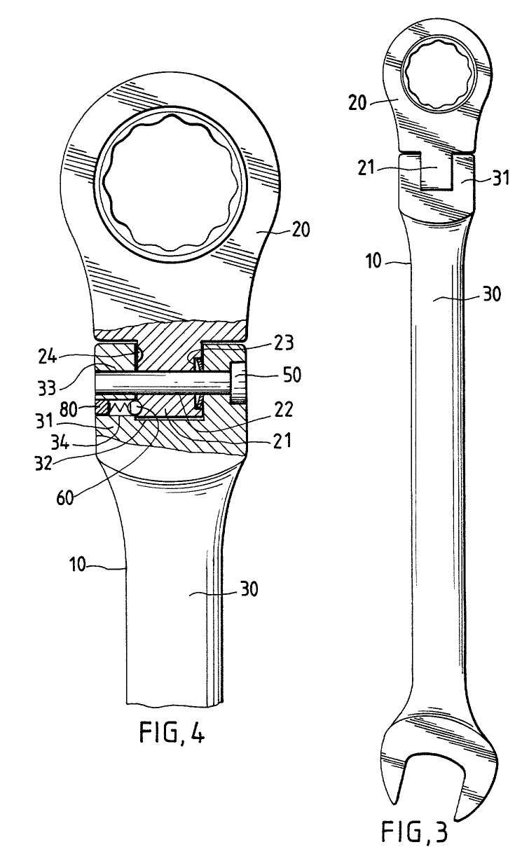

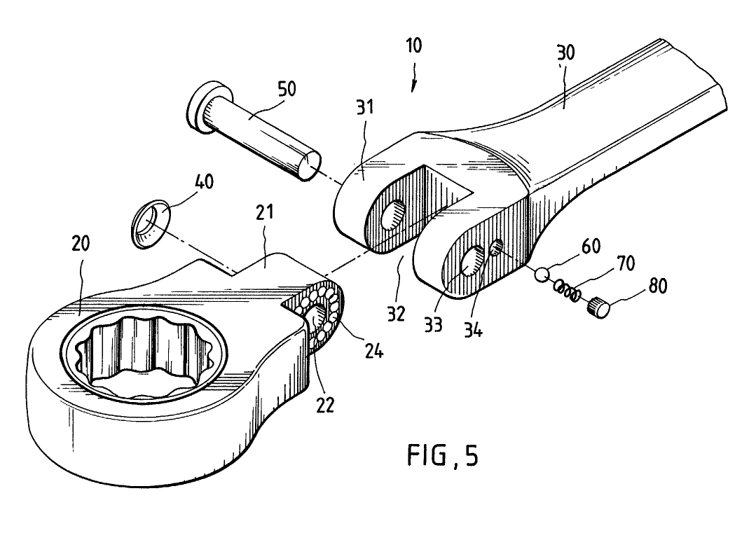

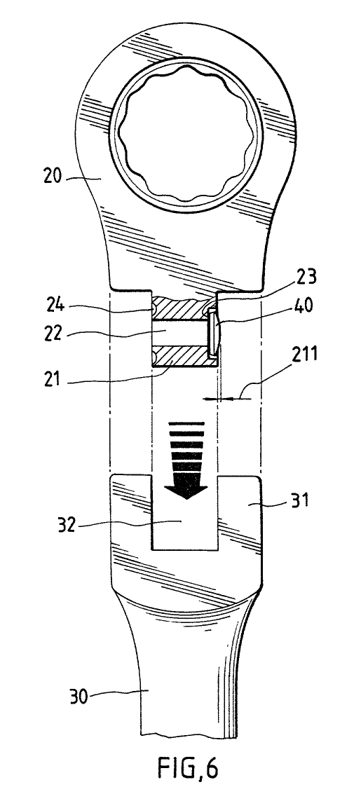

Referring to FIGS. 3 to 6, there is shown a preferred embodiment of combination box and open end wrench constructed in accordance with the invention comprising a head 20 having an enclosed box portion, a cylindrical projection 21 extended from head 20, a hole 22 through cylindrical projection 21, a recessed portion 23 on one side surface of cylindrical projection 21, a plurality of dents 24 on the other side surface of cylindrical projection 21 around hole 22, a central recess 32 on a substantially U-shaped end 31 of handle 30, a hole 33 through end 31, and a threaded aperture 34 adjacent hole 33.

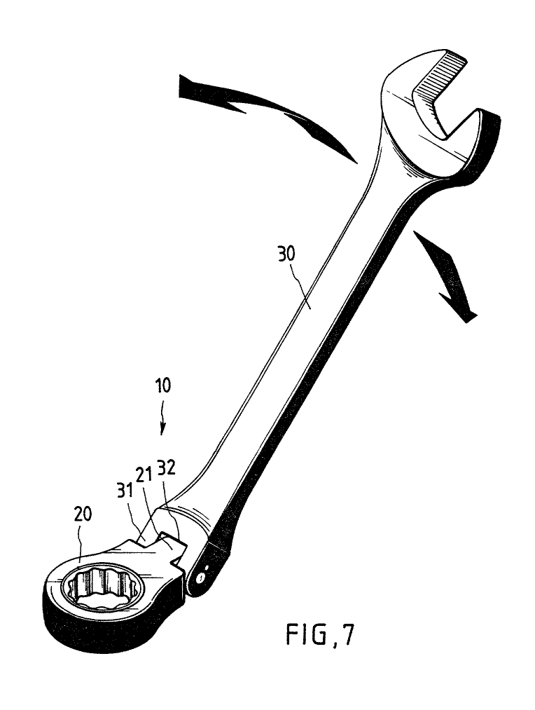

In assembly, first place elastic member 40 in recessed portion 23. At this time, the total width of cylindrical projection 21 and elastic member 40 is slightly larger than that of recess 32. Hence, then compress and insert both cylindrical projection 21 and elastic member 40 into recess 32 until in place. Then insert pin 50 through holes 33 and 22 to rotatably secure head 20 to handle 30. Then insert steel ball 60 and spring 70 into aperture 34 sequentially. Finally, threadedly secure fastener 80 to aperture 34 for urging steel ball 60 against dent 24 by the elastically energized force applied from the spring 70 in a normally engaged state. Referring to FIG. 7 in conjunction with FIGS. 3 to 6, in use simply pivot handle 30 about head 20 to cause steel ball 60 to move from one dent 24 to the other dent 24 so as to obtain a desired angle of head 20 with respect to handle 30. Once adjusted, user may use the wrench to work.

The advantages of the invention are as follows: The engagement of steel ball 60 and dent 24 is still reliable even after a prolonged period of time of use. Further, it is difficult for dirt, dust or the like to accumulate on the joint portion of cylindrical projection 21 and recess 32. Hence, it can preserve the appearance of wrench.

While the invention has been described by means of specific embodiments, numerous modifications and variations could be made thereto by those skilled in the art without departing from the scope and spirit of the invention set forth in the claims.

What is claimed is:

1. An adjustable mechanism mounted in a wrench, said mechanism comprising:
a cylindrical projection extended from a head of said wrench, said projection including a bore, a recessed portion on one end, and a plurality of dents on the other end around said bore; and
a substantially U-shaped joint means at one end of a handle of said wrench, said joint means including a recess, a hole through two vertical portions of said joint means, an aperture adjacent said hole, an elastic member biased between said recessed portion and an inner side of one of said vertical portions, a pin through said hole and said bore to rotatably secure said projection and said joint means, a threaded aperture adjacent said hole, and a depressible spring detent secured within said aperture for urging against one of said dents in a normal position;
whereby pivot said handle about said projection to cause said detent to move from one of said dents to the other dent for adjusting an angle of said head with respect to said handle.

2. The adjustable mechanism of claim 1, wherein said detent comprises a steel ball, a spring, and a fastener.
